(19) United States
(12) Patent Application Publication
(10) Pub. No.: US 2016/0294617 A1
(43) Pub. Date: Oct. 6, 2016

(54) METHOD FOR CONFIGURING A WEB SERVICES GATEWAY AND WEB SERVICES GATEWAY

(71) Applicant: Schneider Electric Industries SAS, Rueil-Malmaison (FR)

(72) Inventors: Michael PATRI, Aschaffenburg (DE); Michael HARNISCHFEGER, Mombris (DE)

(73) Assignee: Schneider Electric Industries SAS, RUEIL-MALMAISON (FR)

(21) Appl. No.: 15/088,276

(22) Filed: Apr. 1, 2016

(30) Foreign Application Priority Data
Apr. 1, 2015 (EP) 15162203.2

(51) Int. Cl. H04L 12/24; H04L 12/66; H04L 29/08

(52) U.S. Cl. CPC H04L 41/0806; H04L 67/02; H04L 69/329; H04L 67/06; H04L 67/32; H04L 12/66

(57) ABSTRACT

The invention relates to a method for configuring a web services gateway, and to a gateway for transforming a web service message from a first web service of a web service server or a web service client in a first network, based on a service-oriented protocol such as SOAP, into a message for a server or client in a second network, based on a standardized protocol such as OPC/UA, and/or vice versa, including: loading a configuration file into the web services gateway, said file comprising definitions for transforming the web service message into the message and/or definitions for transforming the message into the web service message, and generating at least one transformation tool and transformation rules for transforming the at least one web service message into a message, and vice versa, based on the configuration file.

The invention relates to a method for configuring a web services gateway for transforming a web service message from a first web service of a web service server or a web service client in a first network, based on a service-oriented protocol such as SOAP, into a message for a server or client in a second network, based on a standardized protocol such as OPC/UA, and/or vice versa, comprising the following steps:
loading a configuration file into the web services gateway, said configuration file comprising definitions for transforming the web service message into the message, and/or definitions for transforming the message into the web service message, and
generating at least one transformation tool and transformation rules for transforming the at least one web service message into a message, and vice versa, based on the configuration file;
   the invention further relates to a web services gateway for transforming a web service message from a first web service of a web service server or a web service client in a first network, based on a service-oriented protocol such as SOAP, into a message for a client or server of a second network, based on a standardized protocol such as UPC/UA, and vice versa, comprising a configuration interface for loading a configuration file, which contains at least definitions for transforming the web service message from the at least one web service into a message for the client, and vice versa, and means for generating a transformation tool having transformation rules for transforming the at least one web service message into a message of the standardized protocol, and vice versa.

A method for configuring a web services gateway and a web services gateway are described in US 2010/0312863 A1. The described gateway is embodied for making at least one SOAP/XML-based web service accessible to at least one RPC client. For this purpose, at least one mapping file is provided, which comprises definitions for translating at least one first RPC request message from the at least one RPC client into at least one service call for the at least one SOAP/XML-based web service.

The gateway comprises a configuration interface, which is embodied for receiving and for storing at least one mapping file in a storage medium. The gateway is further embodied for generating at least a first sub-program, which is embodied for processing the at least one first RPC request message according to the at least one mapping file.

The configuration interface of the gateway is further embodied for receiving at least one updated mapping file, and for overwriting the corresponding at least one original mapping file without impacting the processing of the at least one first sub-program.

The method known from the prior art enables a simple configuration of the gateway while the gateway is in operation.

However, the above gateway relates to a SOAP/XML-based web service having a fixed protocol, such as SOAP, and established methods, i.e. functions and operations. The known web services gateway has a web service interface that is fixedly determined during operation.

In other words, the method according to the prior art is restricted to the configuration, i.e. the adaptation and transformation rules, of a certain type of web service.

Proceeding therefrom, it is the object of the present invention to develop a method for configuring a web services gateway and a web services gateway of the type described in the introductory part so as to provide a generic web services gateway that allows access to different types of web services that have different protocols, data models and/or methods.

The object with respect to a method is attained according to the invention in that the method comprises the following additional steps:
loading a web service description file as the configuration file, wherein the web service description file comprises definitions for generating a web service-specific web service interface, along with definitions of a data model and/or of operations of an additional web service,
generating the specific web service interface for the additional web service based on the corresponding web service description file, and
generating transformation rules that can be applied on a web service-specific basis for data and operations of the additional web service, based on the definitions of the web service description file, taking into account the data model and the operations of the web service.

In this process, a WSDL, file is loaded as a configuration file, wherein the WSDL file comprises definitions for generating a specific web service interface along with definitions of a data model and/or operations of the web service. The at least one web service interface for the web service is generated based on the corresponding WSDL file, and specifically applicable transformation rules for data and operations of the web service are generated based on the definitions of the WSDL file, taking into account the data model and the methods of the web service.

The method is characterized in relation to the prior art in that different web services, i.e., web services that have different protocols and/or that have different methods for service clients, can be accessed using a standardized service protocol. In other words: a generic web services gateway that can be easily integrated into an existing web service architecture is provided.

The method according to the invention enables the transformation of any web service to services of a standardized protocol using a standardized data model and standardized methods. The method according to the invention can therefore be used to transform or map any service that has an open data model and open operations to a standardized service.

According to a preferred procedure, it is provided that the loading of web service description data such as a WSDL file and the generation of the web service interface along with the generally valid/defined and/or specifically applicable transformation rules for data and methods are carried out at the time of loading.

According to a further preferred procedure, it is provided that the loading of the WSDL file and the generation of the web service interface are initiated in response to a request from the service client.

In the event that the WSDL files do not contain the general definitions that are necessary for transforming the data and/or methods, it is provided that a web service-specific configuration file is loaded, and expanded web service-specific transformation rules are generated on the basis of this file.

The WSDL file and/or the expanded configuration file can be loaded either automatically via the configuration interface of the web services gateway using a web service host address of the required web service, or manually.

The object is attained according to the invention, i.a., in that the configuration interface is embodied for loading a web service description file as a configuration file, wherein the web service description file comprises definitions for generating a web service-specific web service interface and definitions of a data model and/or of operations of an additional web service, and in that the web services gateway comprises means for generating the specific web service interface based on the web service description file corresponding to that web service, along with means for generating transformation rules that can be applied on a web service-specific basis for data and operations of the web service, based on the definition of the web service description file, taking into account the data model and the operations of the additional web service.

It is provided that the configuration interface is embodied for reading a WSDL file as a configuration file, wherein the WSDL file comprises definitions for generating a web service interface and definitions of a data model and/or methods of the web service. The web services gateway further has means for generating a specific web service interface for the web service based on the corresponding WSDL file, and means for generating transformation rules that can be applied on a web service-specific basis for data and methods of the web service, based on the definitions of the WSDL file, and taking into account a data model and the methods of the web service.

The web services gateway according to the invention provides a generic gateway that can be configured such that web services that have an open data model and open methods that follow a first protocol can be accessed by services that have standardized data models and methods that follow a second protocol. This allows OPC/UA clients, e.g. SCADA applications at an operating level, to request web services from web service servers in the form of devices and software applications at a control level.

Furthermore, web service clients such as “AMPLA” can request data from an OPC/US server, e.g. an Open Factory Server (OFS), using an “EcoStruxure web service”.

Mobile devices can also use standardized UPC/UA client applications to request data from a known web service interface.

To enable dynamic operation, the configuration interface is embodied for loading the at least one WSDL file during the web services gateway runtime, and the means for generating the web service interface is embodied such that the web service interface is generated during runtime.

To enable communication with different web services, the web services gateway has a plurality of web service interfaces for web services having different protocols, different data models and/or different operations.

A preferred embodiment provides that a standardized data model and standardized methods, such as function/operation of the second network, are fixedly implemented, i.e. hard coded, in the web services gateways.

It is further provided that the transformation rules for the data models and/or the methods (function/operations) are stored in a memory of the web services gateway or in an external memory.

The protocols, data and/or methods can be transformed by means of cyclic data updates in a cache memory (cached method).

Alternatively, the protocols, data and/or methods may be forwarded directly “on the fly”, i.e. without transformation.

Independently of these methods, the protocols, methods and/or data may also be transformed in a hybrid method, i.e. a combination of the “cached method” and the “on the fly” method.

Further details, advantages and features of the invention are found in the claims, in the features specified therein—alone and/or in combination—and also in the following description of a preferred embodiment example, as illustrated in the set of drawings.

The drawings show:

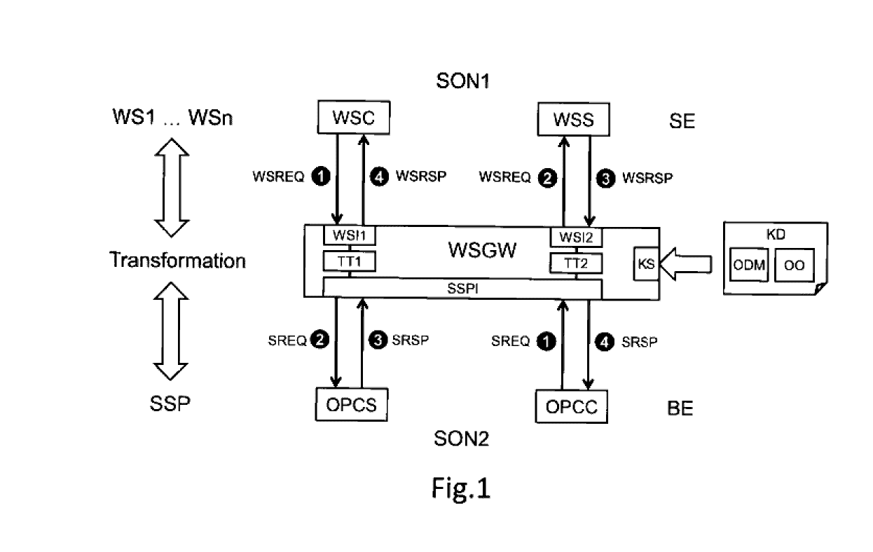

FIG. 1 a schematic representation of a web services gateway communication,

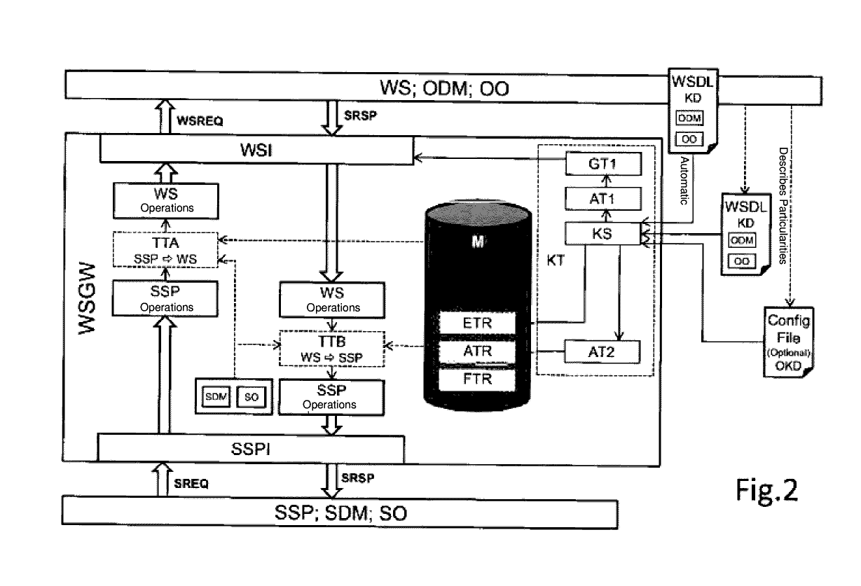

FIG. 2 a schematic representation of the web services gateway according to the invention,

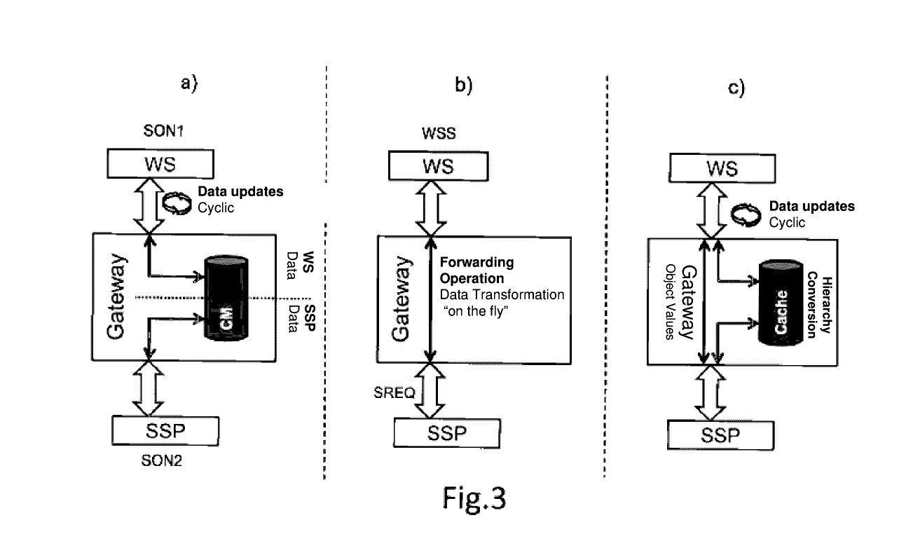

FIG. 3 a schematic representation of various types of mapping methods, and

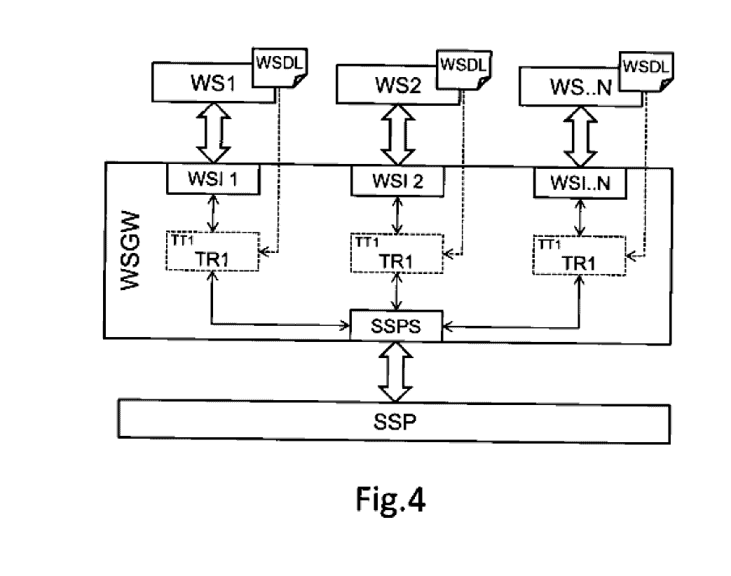

FIG. 4 a schematic representation of a web services gateway system.

FIG. 1 shows a gateway WSGW, in particular a web services gateway, for providing access to at least one web service WS1 . . . WSn of at least one web service server WSS in a first network SON1 at a control level SE, based on a service-oriented protocol WSP, such as SOAP, for at least one service client OPCC in a second network SON2 which has a standardized service protocol SSP, such as OPC/UA, at an operating level BE.

Web services gateway WSGW also offers access to at least one service of a service server OPCS in the second network SON2 by at least one web service client WSC in the first service-oriented network SON1.

Web services gateway WSGW is embodied as a generic gateway, which can be freely configured during runtime. For this purpose, a configuration interface is provided for loading a configuration file KD, which contains at least definitions for transforming a web service message WSREQ, WSRSP of the at least one web service WS1 WSn into a service message SREQ, SRSP of service client OPCC. Web services gateway WSGW further comprises at least one transformation tool TT1 . . . TTn and transformation rules TR, ATR, DTR for transforming the at least one web service message WSREQ, WSRSP into service message SREQ, SRSP.

According to the invention, configuration interface KS of web services gateway WSGW is embodied for loading a web service description file as configuration file KD, wherein the web service description file comprises definitions for generating a web service-specific web service interface WSI1 . . . WSIn, along with definitions of data model ODM and/or of operations OO of web service WS1 . . . WSn being used. Transformation rules ETR, ATR and web service-specific web service interfaces such as WSI1 . . . WSIn can thus be generated based on web service description file KD.

FIG. 2 shows a schematic representation of a detailed structure of web services gateway WSGW for transforming web services WS1 . . . WSn based on an established protocol WSP, e.g. SOAP, but with various data models ODM and various operations OO into services that have a standardized data model SDM and standardized operations SO, based on a standardized protocol SSP such as OPC/UA.

Web services gateway WSGW comprises a configuration tool KT for loading configuration file KD, for generating the at least one web service interface WSI1 . . . WSIn and for generating transformation rules ATR, ETR. Configuration tool KT comprises configuration interface KS for automatically or manually loading configuration file KD, which in the described example is a web service description file, such as an WSDL file, which describes the data model ODM being used and the operations OE of web service WS being used. Once configuration file KD has been loaded, it is analyzed in a first analysis tool AT1, after which the web service-specific web service interface WSI for web service WS is generated by means of a generator tool GT.

Configuration tool KT further comprises a second analysis tool AT2, which is embodied for analyzing configuration file KD and for generating or defining transformation rules ATR, which can be applied on a web service-specific basis, and storing these in a storage medium M.

If the transformation rules ATR that can be applied on a web service-specific basis are not sufficient for carrying out a transformation due to particularities of the data model or the operations of the web service, an optional configuration file OKD can additionally be loaded via the configuration interface, and can be loaded into storage medium M as expanded transformation rules ETR.

Independently of the above, fixedly defined transformation rules FTR are also stored in storage medium M.

Based on transformation rules ATR, ETR, in which the web service-specific data model and the web service-specific operations are already taken into account, transformation tools TTA, TTB are generated, taking into account the standardized data model SDM and the standardized operations SO of the standardized services, with transformation tool TTA being responsible for transforming the standardized service protocol into the web service protocol and transformation tool TTB being responsible for transforming the web service protocol into the standardized service protocol SSP.

Once configuration is complete, web services gateway WSGW functions as follows: The OPC/UA client OPCC, for example in a SCADA application, sends a service request SREQ via the standardized service protocol interface SSPI to web services gateway WSGW. Taking the web service-specific transformation rules ATR and the fixedly defined or configured transformation rules FTR into account, transformation tool TTA transforms the operations and data of the standardized services into operations and data of the web service, which are then forwarded via the web service-specific web service interface WSI as web service request WSREQ to web service server WSS.

Web service server WSS responds with a web service request WSRSP, which is received via web service interface WSI by web services gateway WSGW. The data and/or operations of web service request WSRSP are transformed by transformation tool TTB into data and/or operations of the standardized service and are transmitted via standardized service protocol interface SSPI as service request SRRSP to the OPC/UA client.

If a corresponding web service interface for a service request SRC of an OPC/UA client is not defined in the web services gateway, or if a new web service is made available at the control level SE, a corresponding web service description file KD can be automatically loaded via configuration tool KT as a web service-specific WSDL file, on the basis of which a web service-specific web service interface WSI and transformation rules ATR that can be applied on a web service-specific basis can then be generated. This process can be carried out while web services gateway WSGW is in operation.

Once configuration is complete, the new web service can then be requested by the service client via the web service-specific web service interface WSI.

The protocols, data and/or operations can be transformed in various ways. The defined transformation rules FTR, which are generally implemented as hard-coded into the web services gateway, can be used, for example, to transform a standardized web service.

According to the invention, a transformation can be carried out based on universally valid transformation rules and on the web service description file. The web service description file, e.g. a WSDL file (XML file), defines the syntax and form of the data and/or operations.

For this process, the following preconditions must be met:
1. The web service operations name must begin with a known prefix, such as “Get” or “Set”.
2. The type parameters for “IN”/“OUT” operations must be known.
3. The semantics of the operation must be defined, e.g. the response to “get variable” must be a variable value based on the variable identifier.

The known syntax and form enable the definition of so-called templates.

### EXAMPLE

| GetVariable | | SetVariable | |
|---|---|---|---|
| { | IN: VarName | { | IN: VarName |

| | |
|---|---|
| OUT: VarValue | IN: VarValue |

| | |
|---|---|
| } | } |
| [symbol] Read Template | [symbol] Write Template |

The template defines syntax, form and semantics.
Syntax: “Prefix” or name of the operation
Form: how many and what type of parameters
Semantics: what parameter is, e.g. ID, value, error code, etc.

### Example

| Get... | | |
|---|---|---|
| { | IN | Param1 [symbol] ID |
| | OUT | Param2 [symbol] Value |
| | OUT | Param3 [symbol] Error Code |

} [symbol]
Read Template with 3 parameters

Another type of transformation uses the standardized transformation rules FTR, the transformation rules ATR generated from the web service description file and the expanded transformation rules ETR derived from the optional configuration file OKD. This type of transformation is used with an open WSDL file, i.e., there are no limitations with regard to the syntax and form of the data and/or operations.

Optional configuration data OKD are necessary particularly when a web service operation cannot be described using the standard defined templates.

Existing templates can be used, for example, for fixedly defined functionalities, adapted operation names and the assignment of parameters.

### Example

### Adapted Operation Name

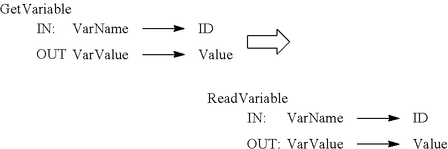

### Assignment of Parameters:

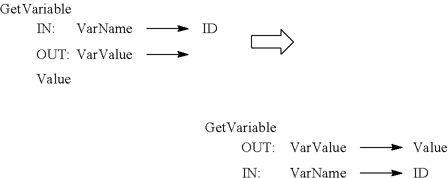

Existing templates must be expanded, e.g. for the expansion of parameters, for the expansion of the variable part of the designator and/or for the adaptation of functionality and semantics.

### Example

### Expansion of Parameters

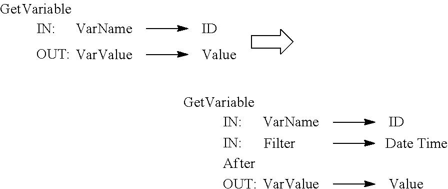

Independently of the above, new templates may also be defined.

### Example

DoSomething
   IN: Param1→ID1
   IN: Param2→ID2
   IN: Param3→ID3
   OUT: Value1→Value1
   OUT: Value2→Value2
   OUT: Value3→Value3

FIG. 3 shows various options for transforming protocols, data and/or operations by means of web services gateway WSGW.

According to the “cached” option shown in FIG. 3a, there is no direct connection between the web service architecture of service-oriented network SNO1 and the service protocol architecture of service-oriented network SON2. Instead, the web service data and the service protocol data are stored temporarily in a cache memory CM. The data are held in reserve in cache memory CM, during which time a data transformation takes place, but not a protocol transformation. The data are updated on a cyclic basis between the web service or services and the cache memory.

FIG. 3b shows an “on the fly” transformation method, in which a web service request SREQ is forwarded directly to web service server WSS. In this method, both the data and the protocol are transformed.

FIG. 3c shows a combination of the “cached” method and the “on the fly” method according to FIGS. 3a and 3b, in which, e.g., time-critical data such as object variables can be accessed directly “on the fly” and other data can be accessed in a “cached” manner.

FIG. 4 shows an embodiment of a web services gateway WSGW having a plurality of web service interfaces WSI1 . . . WSIn for accessing a plurality of different web services WS1 . . . WSn. Each web service interface WSI1 . . . WSIN is assigned a transformation tool TT1 . . . TTn having transformation rules TR1 . . . TRn that have been generated on the basis of the web service-specific WSDL file.

The described embodiment of web services gateway WSGW allows the various web services WS1 . . . WSn to be accessed by a service client OPCC via the standardized service protocol SSP and the standardized service protocol interface SSPI, and vice versa.

What is claimed is:

1. A method for configuring a web services gateway for transforming a web service message from a first web service of a web service server or a web service client in a first network, based on a service-oriented protocol such as SOAP, into a message for a server or client in a second network, based on a standardized protocol such as OPC/UA, and/or vice versa, the method comprising:
loading a configuration file into the web services gateway, said file comprising definitions for transforming the web service message into the message, and/or definitions for transforming the message into the web service message;
generating at least one transformation tool and transformation rules for transforming the at least one web service message into a message, and vice versa, based on the configuration file;
loading a web service description file as the configuration file, wherein the web service description file comprises definitions for generating a web service-specific web service interface, along with definitions of a data model and/or of operations of an additional web service;
generating the specific web service interface for the additional web service based on the corresponding web service description file; and
generating transformation rules that can be applied on a web service-specific basis for data and operations of the additional web service, based on the definitions of the web service description file, taking into account the data model and the operations of the web service.

2. The method according to claim 1, wherein the loading of the web service description file and the generation of the web service interface and/or the generation of the transformation rules that can be applied on a web service-specific basis for data and operations are carried out during runtime.

3. The method according to claim 1, wherein the loading of the web service description file and the generation of a web service interface are initiated in response to a request from the gateway or the service client.

4. The method according to claim 1, wherein, for the generation of web service-specific expanded transformation rules, a web service-specific expanded configuration file is preferably loaded during runtime.

5. The method according to claim 1, wherein the web service description file and/or the expanded configuration file are automatically loaded via a configuration interface of the web services gateway using a web service host address of the required web service.

6. The method according to claim 1, wherein the we service description file and/or the expanded configuration file are loaded manually.

7. The method according to claim 1, wherein a WSDL file is loaded as the web service description file.

8. A web services gateway (WSGW) for transforming a web service message (WSRE2, WSRESP) from a first web service (WS) of a web service server (WSS) or a web service client (WSC) in a first network (SON1), based on a service-oriented protocol such as SOAP, into a message (SREQ), SR5P) for a client (OPCC) or server (OPCS) in a second network (SON2), based on a standardized protocol such as OPC/UA, and vice versa, said gateway comprising:
a configuration interface (KS) for loading a configuration file (KD), which contains at least definitions for transforming the web service message (WSREQ, WSRSP) from the at least one web service (WS) into a message (SREQ, SRSP) for the client (OPCC), and vice versa, and means (KT) for generating a transformation tool (TTA, TTB) having transformation rules (ETR, ATR, FTR) for transforming the at least one web service message (WSRE2, WSRSP) into a message that follows the standardized protocol, and vice versa;
wherein the configuration interface (KS) is embodied for loading a web service description file (WSDL) as a configuration file, wherein the web service description file (WSDL) comprises definitions for generating a web service-specific web service interface (WSI), along with definitions of a data model (ODM) and/or operations (OD) of an additional web service (WS); and
wherein the web services gateway (WSGW) comprises means for generating the specific web service interface (WS) based on the web service description file that corresponds to the web service, along with means for generating transformation rules (ATR) that can be applied on a web service-specific basis for data and operations of the web service (WS), based on the definition of the web service description file, taking into account the data model and operations of the additional web service.

9. The web services gateway according to claim 8, wherein the configuration interface (KS) is embodied for loading the at least one web service description file (WSDL) during runtime, and in that the means (AT1, GT1) for generating the web service interface (WS) is embodied for generating the web service interface (WS) during runtime.

10. The web services gateway according to claim 8, wherein the web services gateway (WSGW) has a plurality of web service interfaces (WSI1 . . . WSIn).

11. The web services gateway according to claim 8, wherein the web services gateway (WSGW) has a plurality of web service interfaces (WSI1, . . . , WSIn) for web services (WS1, . . . , WSn) having different protocols and/or different functions and/or operations.

12. The web services gateway according to claim 8, wherein definitions of a data model and/or of operations of the services of the standardized protocol are fixedly implemented in the web services gateway.
